(19) United States
(12) Patent Application Publication
(10) Pub. No.: US 2022/0082894 A1
(43) Pub. Date: Mar. 17, 2022

(54) COLOR CHANGEABLE PLASTIC

(71) Applicants: HYUNDAI MOTOR COMPANY, Seoul (KR); KIA CORPORATION, Seoul (KR); Pusan National University Industry-University Cooperation Foundation, Busan (KR)

(72) Inventors: Dong Eun Cha, Hwaseong-si (KR); Hyun Kyung Kim, Hwaseong-si (KR); Jun Hong Choi, Busan (KR); Jong Seung Park, Busan (KR)

(21) Appl. No.: 17/240,423

(22) Filed: Apr. 26, 2021

(30) Foreign Application Priority Data
Sep. 16, 2020 (KR) 10-2020-0119240

(51) Int. Cl. G02F 1/1516; G02F 1/153

(52) U.S. Cl. CPC G02F 1/15165; G02F 2201/12; G02F 2001/1536; G02F 1/1533

(57) ABSTRACT

A color changeable plastic, the color change rate of which increases when a voltage is applied, is applicable to various structures by a spray coating method. The color changeable plastic includes a first electrode layer having conductivity; a color changeable layer disposed on the first electrode layer to cover an upper surface and a side surface of the first electrode layer, and including a material whose color changes depending on whether a voltage is applied; and a second electrode layer having conductivity, and disposed on the color changeable layer to cover an upper surface and a side surface of the color changeable layer.

### CROSS REFERENCE TO RELATED APPLICATION

The present application claims the benefit of priority to Korean Patent Application No. 10-2020-0119240, filed on Sep. 16, 2020 in the Korean Intellectual Property Office, the entire contents of which is incorporated herein by reference.

### TECHNICAL FIELD

The present disclosure relates to a color changeable plastic, the color of which changes depending on whether voltage is applied or not.

### BACKGROUND

Recently, the importance of color marketing is increasing in various fields such as home appliances or mobile devices. In particular, the necessity of color marketing is also required in an automobile industry to realize high-quality and differentiated colors.

Thus, a high-quality color image is attempted using electrochromism. Electrochromism refers to a phenomenon in which a color reversibly changes when a redox reaction electrochemically occurs in an electrode material. The principle of electrochromism is as follows: when Li⁺ or H⁺ and electrons are injected into WO₃ that is a representative reducing coloration material, an electrochromic operation is performed to impart a color, and, when Li⁺ or H⁺ and electrons are released, a transparent state is obtained. In contrast, in the case of an oxidizing coloration material such as MnO or LiO, when LI+ or H+ and electrons are released, a colored state is obtained, and when they are injected, a transparent state is obtained. In other words, according to the related art, a stacking structure is made of a glass substrate—a transparent electrode—a reducing coloration material (WO3)—an electrolyte (Li⁺, H⁺)—an oxidizing coloration material (NiO)—a transparent electrode—a glass substrate, and then is sealed to form an electrochromic device.

The conventional electrochromic device is problematic in that it is difficult to apply various substrate materials, and it is impossible to manufacture and form a material when the electrochromic device is applied to the material having a distortion surface.

The information disclosed in the Background section above is to aid in the understanding of the background of the present disclosure, and should not be taken as acknowledgement that this information forms any part of prior art.

### SUMMARY

Accordingly, the present disclosure has been made keeping in mind the above problems occurring in the related art, and an objective of the present disclosure is to provide a color changeable plastic which is increased in color change rate when a voltage is applied and is applicable to various structures by a spray coating method.

In order to achieve the objective of the present disclosure, a color changeable plastic includes a first electrode layer having conductivity; a color changeable layer disposed on the first electrode layer to cover an upper surface and a side surface of the first electrode layer, and including a material whose color changes depending on whether a voltage is applied; and a second electrode layer having conductivity, and disposed on the color changeable layer to cover an upper surface and a side surface of the color changeable layer, wherein contact surfaces of the color changeable layer with the first electrode layer and the second electrode layer may extend along upper, lower, and side surfaces of the color changeable layer, so that a color change rate may be increased when a voltage is applied.

Each of the first electrode layer and the second electrode layer may include a composite of silver nanowire and polystyrene sulfonate.

Each of the first electrode layer and the second electrode layer may include divinyl sulfone (DVS), as a cross-linking agent, added to the composite.

The color changeable layer may include octa-hexyl viologen substituted polyhedral oligomeric silsesquioxane (OHV-POSS).

The color changeable layer may further include an ionic medium composed of PVDF-HFP.

A transparent clear coat layer may be disposed on the second electrode layer to cover the first electrode layer, the color changeable layer, and the second electrode layer.

The first electrode layer may further include a photocatalytic layer thereunder.

The first electrode layer, the color changeable layer, and the second electrode layer may be coupled to an upper surface of a plastic substrate.

The color changeable plastic configured as described above is increased in color change rate when a voltage is applied and is applicable to various structures by a spray coating method.

### BRIEF DESCRIPTION OF THE DRAWINGS

The above and other objectives, features, and other advantages of the present disclosure will be more clearly understood from the following detailed description when taken in conjoint with the accompanying drawings, in which:

FIGS. 1 and 2 are diagrams illustrating a color changeable plastic according to one exemplary embodiment of the present disclosure;

FIG. 3 is a diagram illustrating another exemplary embodiment of the color changeable plastic shown in FIG. 1; and

FIGS. 4, 5 and 6 are diagrams illustrating the operational effect of the present disclosure.

### DETAILED DESCRIPTION

Hereinafter, a color changeable plastic according to the preferred embodiment of the present disclosure will be described with reference to the accompanying drawings.

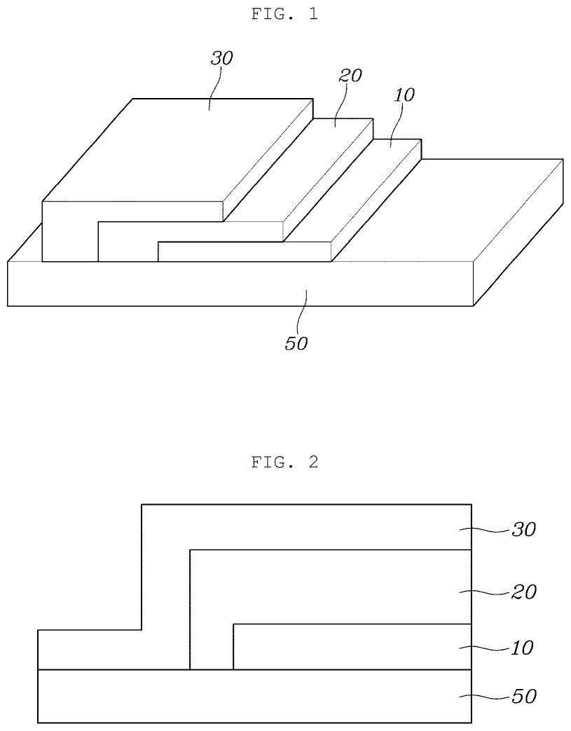

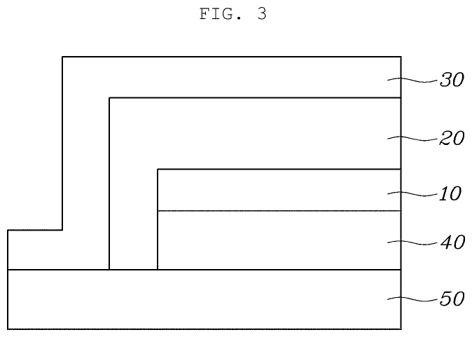

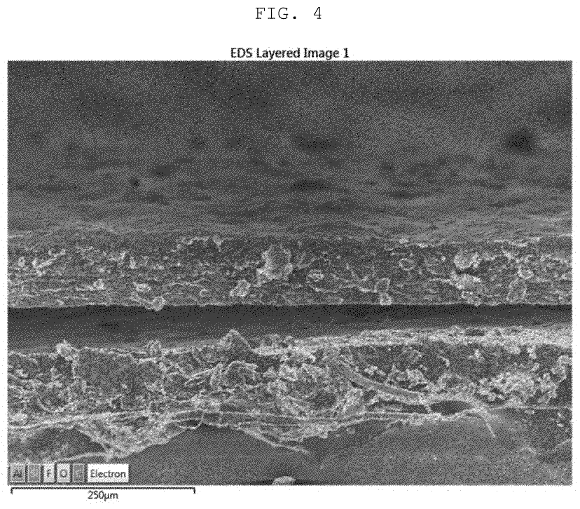

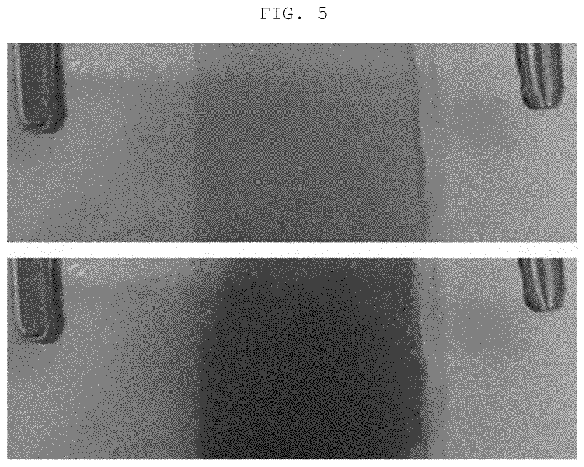

FIGS. 1 and 2 are diagrams illustrating a color changeable plastic according to one exemplary embodiment of the present disclosure, FIG. 3 is a diagram illustrating another embodiment of the color changeable plastic shown in FIG. 1, and FIGS. 4, 5 and 6 are diagrams illustrating the operational effect of the present disclosure.

As shown in FIG. 1, a color changeable plastic according to one exemplary embodiment of the present disclosure includes a first electrode layer 10 having conductivity, a color changeable layer 20 disposed on the first electrode layer 10 to cover an upper surface and a side surface of the first electrode layer 10. The color changeable layer 20 includes a material whose color changes depending on whether a voltage is applied. The color changeable plastic further includes a second electrode layer 30 having conductivity and disposed on the color changeable layer 20 to cover an upper surface and a side surface of the color changeable layer 20.

The first electrode layer 10, the color changeable layer 20, and the second electrode layer 30 may be coupled to an upper surface of a plastic substrate 50. In other words, according to one exemplary embodiment of the present disclosure, as the first electrode layer 10, the color changeable layer 20, and the second electrode layer 30 may be applied in a spray method, they may be coupled to the plastic substrate 50, and the change of the color may be implemented on the plastic substrate 50. Thus, when it is applied to a vehicle, the color of the vehicle exterior may change so as to realize a high-quality design and improve marketability. Although it is described herein that the first electrode layer 10, the color changeable layer 20, and the second electrode layer 30 are stacked onto the plastic substrate 50, they may be applied to substrates of various materials.

The upper surface of each layer may refer to a surface facing upwardly in the stacking direction away from the plastic substrate 50, and the lower surface of each layer may refer to a surface opposing the respective upper surface. The side surface of each layer may refer to a surface connecting the respective upper surface to the respective lower surface.

Here, the first electrode layer 10 and the second electrode layer 30 include transparent electrodes, so that a change in color of the color changeable layer 20 may be seen from the outside. In other words, a voltage is applied between the first electrode layer 10 and the second electrode layer 30 to control the conductivity of the color changeable layer 20, thus changing the color of the color changeable layer 20.

In particular, the first electrode layer 10, the color changeable layer 20, and the second electrode layer 30 of the present disclosure form a stacked structure which provides contact surfaces with one layer to another to perform the fast reaction of the color changeable layer 20 when a voltage is applied thereto. In other words, the color changeable layer 20 is disposed on the first electrode layer 10 to cover the upper surface and the side surface of the first electrode layer 10, and the second electrode layer 30 is disposed on the color changeable layer 20 to cover the upper surface and the side surface of the color changeable layer 20. Thereby, as shown in FIG. 2, when a voltage is applied through the first electrode layer 10 and the second electrode layer 30, the voltage is applied to the upper surface, a lower surface, and the side surface of the color changeable layer 20, thus increasing a color change rate through the electrochromic material of the color changeable layer 20.

As such, the contact surfaces of the color changeable layer 20 with the first electrode layer 10 and the second electrode layer 30 extend along the upper surface, the lower surface, and the side surface, so that a color change rate is increased when a voltage is applied, thus improving marketability due to a rapid change in color and design. Hereinafter, the first electrode layer 10, the second electrode layer 30, and the color changeable layer 20 according to one exemplary embodiment of the present disclosure will be described in detail.

Each of the first electrode layer 10 and the second electrode layer 30 is made of a composite of silver nanowire and polystyrene sulfonate (PEDOT:PSS). Thus, each of the first electrode layer 10 and the second electrode layer 30 has the transmittance of 80% or more. Furthermore, in the first electrode layer 10 and the second electrode layer 30, polystyrene sulfonate that is an organic conductive polymer material fills a gap between silver nanowires, thus improving overall uniformity and electrical conductivity.

Each of the first electrode layer 10 and the second electrode layer 30 may include divinyl sulfone (DVS), as a cross-linking agent, added to the composite. By adding divinyl sulfone to the composite of silver nanowire and polystyrene sulfonate, an independent conductive film is formed due to reaction between polystyrene sulfonate and divinyl sulfone. Therefore, the first electrode layer 10 and the second electrode layer 30 are improved in stability, maintain conductivity, and are improved in mechanical properties. Furthermore, the first electrode layer 10 and the second electrode layer 30 may be manufactured by a spray coating method, and divinyl sulfone as the cross-linking agent is added to a hybrid composite material composed of silver nanowire and polystyrene sulfonate, so that spray coatability is excellent.

According one exemplary embodiment of the present disclosure, the color changeable layer 20 may include octa-hexyl viologen substituted polyhedral oligomeric silsesquioxane (OHV-POSS). In other words, the color changeable layer 20 is an organic and inorganic hybrid material produced by combining an inorganic material such as POSS and an organic material such as viologen, and may be produced by substituting a reactive functional group with one to eight units of monohexyl-viologen that is an electrochromic material. The octa-hexyl viologen substituted polyhedral oligomeric silsesquioxane (OHV-POSS) produced through such a process may quickly change color, may be driven even at a low voltage, and may realize a vivid color.

The color changeable layer 20 may further include an ionic medium composed of PVDF-HFP. The ionic medium is a solution including lithium bis(trifluoromethanesulfonyl)imide (LiTFSI), glycidyl polyhedral oligomeric silsesquioxane (glycidyl POSS), and poly(vinylidene fluoride-co-hexafluoropropylene) (PVDF-HFP), is excellent in spray coatability, and is heat-curable. As such, as the ionic medium includes Glycidyl POSS and electrolyte LiTFSI, the ionic medium may be applied in a spray method. As such an ionic medium is added to the color changeable layer 20, it is easy to form the color changeable layer 20 as a film layer in a spray coating method. The above-described color changeable layer 20 and ionic medium may form a single layer or a plurality of layers depending on the material and size of the substrate.

According one exemplary embodiment of the present disclosure, a transparent clear coat layer is disposed on the second electrode layer 30 to cover the first electrode layer 10, the color changeable layer 20, and the second electrode layer 30. In other words, the clear coat layer may include acryl-based composition that is photo-curable or heat-curable and is excellent in surface hardness, and is disposed to cover the first electrode layer 10, the color changeable layer 20, and the second electrode layer 30 to protect the first electrode layer 10, the color changeable layer 20, and the second electrode layer 30 from an outside. Such a clear coat layer may be applied to the outside in the spray method, and is transparent to allow the color change of the color changeable layer 20 to be observed from the outside. Furthermore, even if it is applied to the substrate having a distortion surface, the stacked state is maintained, thus preventing the performance of the first electrode layer 10, the color changeable layer 20, and the second electrode layer 30 from being deteriorated.

Further, a photocatalytic layer 40 may be further arranged under the first electrode layer 10. The photocatalytic layer 40 may include TiO₂, and a redox reaction rate may be increased by the photocatalytic layer 40 to enhance a color change rate.

The color change of the present disclosure will be further described. FIG. 4 illustrates an example in which a color change is performed. A color changes through the movement of the electrochromic material between the layers. In other words, a polymer matrix such as PVDF-HFP is located at an upper position to form a film (cyan color). Therebetween, the color changeable material (magenta color) containing Si and the ion electrolyte (yellow color) containing TFSI are located, and some of Ag (green color) from the clear coat layer and the electrode layer may be left at the upper position. As such, it can be seen that the electrochromic material moves between the layers when a voltage is applied, and the change of the color is triggered through the redox reaction by the application of power.

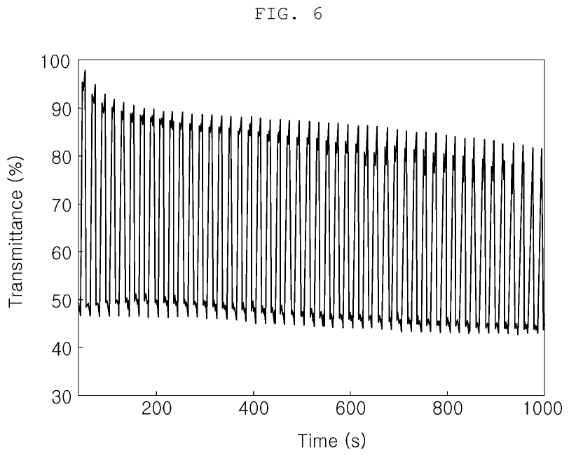

Thereby, as shown in FIG. 5, it can be seen that color changes depending on whether power is applied or not. The color changeable layer 20 may implement various colors by changing the chemical structure of the POSS-Viologen hybrid derivative. In other words, a color may be tuned according to the component and type of the electrode.

Furthermore, as shown in FIG. 6, the color change level of the electrochromic material of the color changeable plastic according to the above exemplary embodiments of the present disclosure, is not relatively large when the number of color changes increases by the application of voltage, thus exhibiting excellent repeatability and maintaining a color. In other words, assuming that a reciprocal number of a quantity in which an ion charge quantity per area is reduced is a device area, the effect of the number of color changes on the device area may be slight.

As described above, according to one exemplary embodiment of the present disclosure, the first electrode layer 10, the color changeable layer 20, and the second electrode layer 30 are stacked through the spray coating method, so that they may be applied to a glass or film substrate as well as a slightly rough surface, a curved surface, or a distorted structure. Furthermore, as the independent film is formed by the coating method, a separate substrate is not required, and the present disclosure may be widely applicable to various structures. Furthermore, due to the stacking structure and characteristics of the first electrode layer 10, the color changeable layer 20, and the second electrode layer 30, a color change rate is enhanced and durability is ensured.

Although the present disclosure was described with reference to specific embodiments shown in the drawings, it is apparent to those skilled in the art that the present disclosure may be changed and modified in various ways without departing from the scope of the present disclosure, which is described in the following claims.

What is claimed is:

1. A color changeable plastic, comprising:
a first electrode layer having conductivity;
a color changeable layer disposed on the first electrode layer to cover an upper surface and a side surface of the first electrode layer, and including a material whose color changes depending on whether a voltage is applied; and
a second electrode layer having conductivity, and disposed on the color changeable layer to cover an upper surface and a side surface of the color changeable layer,
wherein contact surfaces of the color changeable layer with the first electrode layer and the second electrode layer extend along upper, lower, and side surfaces of the color changeable layer, so that a color change rate is increased when a voltage is applied.

2. The color changeable plastic of claim 1, wherein each of the first electrode layer and the second electrode layer includes a composite of silver nanowire and polystyrene sulfonate.

3. The color changeable plastic of claim 2, wherein each of the first electrode layer and the second electrode layer comprises divinyl sulfone (DVS), as a cross-linking agent, added to the composite.

4. The color changeable plastic of claim 1, wherein the color changeable layer includes octa-hexyl viologen substituted polyhedral oligomeric silsesquioxane (OHV-POSS).

5. The color changeable plastic of claim 1, wherein the color changeable layer further comprises an ionic medium including PVDF-HFP.

6. The color changeable plastic of claim 1, wherein a transparent clear coat layer is disposed on the second electrode layer to cover the first electrode layer, the color changeable layer, and the second electrode layer.

7. The color changeable plastic of claim 1, wherein the first electrode layer further comprises a photocatalytic layer thereunder.

8. The color changeable plastic of claim 1, wherein the first electrode layer, the color changeable layer, and the second electrode layer are coupled to an upper surface of a plastic substrate.
